(19) United States
(12) Patent Application Publication
(10) Pub. No.: US 2024/0220082 A1
(43) Pub. Date: Jul. 4, 2024

(54) SEMANTIC SORTING SYSTEM FOR A NAVIGATIONAL PANEL OF AN ELECTRONIC DOCUMENT MANAGEMENT SERVICE

(71) Applicants: Atlassian Pty Ltd., Sydney (AU); Atlassian US, Inc., San Francisco, CA (US)

(72) Inventors: Swati Katta, Mountain View, CA (US); Lauren Speers, Mountain View, CA (US); Hayley Howell, Los Altos, CA (US)

(21) Appl. No.: 18/092,147

(22) Filed: Dec. 30, 2022

(51) Int. Cl. G06F 3/0483; G06F 3/0482; G06F 3/0486; G06F 16/901; G06F 16/906; G06F 16/93

(52) U.S. Cl. CPC G06F 3/0483; G06F 3/0482; G06F 3/0486; G06F 16/9027; G06F 16/906; G06F 16/93

(57) ABSTRACT

A content collaboration platform system may have an automatically generated semantic sorting user interface. The content collaboration platform may be configured to display pages associated with a workspace in a navigational panel. The navigational panel may include a hierarchical element tree that displays an array of hierarchically arranged tree elements. Each tree element can be selectable to cause display of page content in a content panel. A user may select a semantic sort command from the navigational panel. In response to the semantic sorting command, the navigational panel may be updated with automatic section headers that are key phrases of the corresponding set of pages within the workspace. The section headers may be displayed as parent elements within the tree. The set of pages from the workspace may be grouped under each of the section headers and may be displayed as children of the key phrases.

### TECHNICAL FIELD

Embodiments described herein relate to a graphical user interface for visually organizing electronic documents or pages. In particular, the embodiments described relate to a sorting system for semantically clustering user-generated electronic documents or pages.

### BACKGROUND

Electronic collaboration platforms allow users to freely create electronic content. These platforms may be used to share and manage large volumes of these user-generated electronic documents and other electronic content. However, the number of electronic documents and other user-generated content may be difficult to organize, access, and visualize. The systems and techniques described herein can be used to semantically sort user-generated content and visually rearrange user-generated content by semantically similar categories.

### SUMMARY

The embodiments and examples described herein are directed to methods for semantically sorting electronic content of an electronic document collaboration service. The method may include causing display of a graphical user interface of a document space. A graphical user interface may have a content panel configured to display page content of a page and a navigational panel having a hierarchical element tree having a set of tree elements, each tree element of the set of tree elements can be selectable to cause display of page content of a respective page in the content panel. The method may also include causing display of the hierarchical element tree in the navigational panel in a first mode in which the array of tree elements are arranged in an order determined by a hierarchical relationship between adjacent tree elements. In response to receiving an automatic semantic sorting command, a service may obtain page content for a set of pages within the document space. The pages may be used to compute, at a backend application, a set of vectors, each vector determined using page content of a respective page of the set of pages within the document space. Afterwards, a set of page clusters may be generated using the set of vectors. A keyword may be extracted from each cluster. Display of the hierarchical element tree in the navigational panel in a second mode in which the array of tree elements are arranged in a grouping determined by the set of page clusters may be caused at the frontend application.

In some examples, the second mode of the navigational panel includes a set of section headers generated from each of the extracted keywords, each of the section headers from the set of section headers caused to display as a parent within the element tree and each set of page clusters may be arranged under the respective section header, each page of the set of page clusters may be caused to display as children of the respective section header. As another example, the methods described herein may include causing display, in a second mode, of a toggle view option and, in response to a user selection of the toggle view option, updating display of the navigational panel to the first mode. Furthermore, in response to a user selection of an element, the content panel can be configured to display page content and, upon toggling to the first mode, the navigational panel can include the array of tree elements arranged in the order determined by the hierarchical relationship between adjacent tree elements and the selected element positioned within the hierarchical relationship, the selected element is configured to be accentuated with respect to the array of tree elements.

The graphical user interface of the document space, as described herein, may be displayed in a web browser. In response to a user selection of an element in the element tree, page content may be displayed in the content panel within the web browser and, in response to a user selection within the content panel, the content panel can transitioned between edit mode and view mode of the page content.

As an example of the sorting service, each vector of the set of vectors computed for each page element may be calculated using a respective title of a respective page of the set of pages. In some cases, each vector of the set of vectors can be calculated based at least in part on the respective content of a respective page of the set of pages.

A user may transition between a first mode and a second mode of the navigational panel, and each mode may have different functions for the user. For example, in the second mode, in response to a user drag input with respect to a page element in the element tree, the user may change a position of the page element from a first location to a second location within the element tree. As another example, in response to a user selection, the user may change the hierarchical relationship of the tree elements of the first mode to be equal to the second mode.

The methods and system described herein may be directed to a method for semantically reorganizing a page tree within a navigational panel. This method may include causing display of a graphical user interface of a space. The space may include a navigational panel having a page tree with a set of user-generated page elements and a set of parent elements configured to hierarchically arrange the user-generated page elements. The space may also include a content panel configured to display, in response to a user selection of a page element, page content of the selected page element. The backend and the frontend applications may cooperate to cause display of the navigational panel in a first mode in which a hierarchical arrangement of the page tree is user-generated. In response to a user selection of a semantic sort option, the set of user-generated pages of the space may be queried. Next, a backend application may compute a semantic similarity metric, this semantic similarity metric can be calculated from page content of each of the set of user-generated pages. A backend application may then cluster the groups of user-generated pages, each of the user-generated pages in each cluster may meet a semantic similarity criteria. A backend application may also generate a set of key phrases, each of the key phrases from the set of key phrases may be extracted from each of the generated clusters. An updated display of the navigational panel may be caused to display the second mode. The second mode can include a section header generated from the set of extracted key phrases and a subset of pages, corresponding to a generated cluster. In some examples, each of the section headers is displayed as a parent element of the page tree and each page of the subset of pages is displayed as children elements of a corresponding section header.

In some examples, the backend application may query at least one restricted page, each restricted page associated with user view permission, and suppress display, at a frontend application, of the at least one restricted page in the second mode. In the second mode, according to examples, in response to a user selection of an element, display of page content associated with the selected element in the content panel can be caused and, in response to a user selection, the navigational panel may toggle from the second mode to the first mode, the selected element can be displayed as underlined within the navigational panel.

To extract keywords or key phrases, the backend application may rank a group of extracted key phrases, where each ranking can be based on weighing at least on a frequency of the key phrase with respect to the cluster. Once ranked, the service may select a lowest ranked key phrase from the group of extracted key phrases as the section header of the cluster and display the selected section header in second mode.

A method for semantically sorting pages in a content collaboration platform in response to a user selection of a semantic sort view may include causing display of a content collaboration platform space in a client web browser. The content collaboration platform space may include a content panel configured to display page content of a user-selected page, a navigational panel configured to display a page tree, the page tree may have an array of user-generated elements contained within the space, and a sorting menu having a selectable semantic sort view. In response to a user selection of a semantic sort view within the menu, an array of attributes may be extracted from each of the user-generated elements from the array of user-generated elements within the content collaboration platform space. The backend application may obtain vector representations from each of the array of attributes. Next, groupings may be formed from the set of vector representations, each vector representation may fall within each grouping meeting a semantic similarity criteria. The backend application may also extract key phrases. As a result of this process, display of the semantic sort view of the navigational panel may be updated. The semantic sort view can include at least one header generated from at least one key phrase extracted from the grouping and at least one grouping of an array of elements corresponding to the generated header. In other examples, the method may also include, in response to a user selection of a page element in the semantic sort view, causing display of page content corresponding to the selected page element in the content panel and, in response to a user selection of a section header, causing display of a set of page frames in the content panel, each page of the set of page frames can correspond to each page element of the grouping under the generated header. The array of attributes, in some cases, includes at least each title of each of the array of user-generated elements and page content comprising an image.

Based on user view and edit permissions, a user may edit and/or rename a title of a page element. In some examples, in response to a user input renaming a page element, a new vector representation for the renamed page element may be computed. The new vector representation may be grouped in accordance with the semantic similarity criteria of the new vector representation. Display of an updated navigational panel may be caused, the updated navigational panel may have the renamed page element under the computed grouping. In some cases, the semantic similarity criteria is calculated based at least on cosine similarity and the keyword extraction criteria is calculated at least based on statistical methods. The method may further include user feedback services. For example, while in the semantic sort view, in response to a user drag input of a page element, the navigational panel may be updated to display the page element in a user-selected location, and user profile may be updated to save the user-selected location.

Other embodiments are also disclosed.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system for semantically sorting elements in a navigational panel of a content collaboration platform using automatically generated keywords, such as described herein.

FIGS. 2A-2D depict example views of a graphical user interface, in accordance with embodiments described herein.

FIG. 3 depicts an example view of a graphical user interface having user feedback options with respect to sorted elements displayed in a navigational panel, in accordance with the embodiments described herein.

FIG. 4 depicts an example view of a graphical user interface of semantically sorted elements in a navigational panel having user inputs, in accordance with the embodiments described herein.

FIGS. 5A-5D depict example views of a graphical user interface, in accordance with embodiments described herein.

FIG. 6 depicts a flowchart of an example process for semantically sorting navigational elements corresponding to pages and generating semantically relevant headers in a content collaboration platform in accordance with embodiments described herein.

FIG. 7 depicts an example hardware for devices of the systems described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The systems and methods described herein are directed to a document management platform or an electronic content management system that allows users to create and publish electronic content using a client application. In particular, the systems and methods described may be applicable to document management platforms that use a web browser client application or other client application with content creation, viewing, and editing interfaces for creating and viewing electronic content. As described herein, the interface may include a content region or panel displaying user-generated content and a navigation region or panel displaying selectable elements that can be used to navigate to different electronic documents. In some implementations, the navigational region or panel includes a page tree or document tree that includes a list of selectable elements, where each element is associated with a respective electronic document. The system and methods described herein are directed to a semantic sorting service that can be used to visually rearrange elements of the page tree according to a semantic similarity criteria and automatically generate titles or section headers for each semantically similar group based on an analysis of the document content within a space.

As described herein, the client application may include an automatic semantic sorting service that, when selected, semantically sorts elements of a page tree based on the user-generated content of the documents or pages. Specifically, the sorting service may group or cluster elements of a page tree by analyzing the content to extract or to generate keywords and automatically organize the respective elements of semantically related pages under section headers generated in accordance with those keywords. As a result of this semantic sorting, a user may intuitively navigate electronic content within a space.

Content collaboration platforms allow users to work collaboratively with other users. In particular, content collaboration platforms allow users to create, store, and manage electronic content stored as electronic documents, also referred to herein as pages or documents. For example, a user may create a project strategy or product documentation, share the strategy or product documentation with team members, and allow others to edit the document, as allowed by a content permissions scheme. The user may communicate with those involved in a project through a communication application within the content collaboration platform. The user may also leverage other tools within the platform such as labels, tags, mentions, and so on to work collaboratively with other users. Users may, for example, edit the document to update on the progress of the project, to add additional information, to provide missing data, and so on. In many cases, other documents may be generated using the information from the original document. The document may also be shared with another organization or another team within the organization, who in turn may generate more data, produce their own documents, share with others, and so on.

Democratically driven collaboration platforms, such as those described herein, allow users and organizations to adapt these tools to their needs without developing purpose-made platforms. In many cases, the structure and the operation of these platforms are not centrally managed. Thus, the bottlenecks associated with administering a database are not generally present. Collaboration platforms may reduce the risk of lost work due to hardware malfunction, or due to changes in personnel, for example. These platforms may offer continuously improving functionality without the need for tedious hardware updates to a user's computer or without the need for demanding computing resources from the client device.

However, in cases where a content collaboration platform is widely used by an organization or group of users, content collaboration platforms tend to generate large swaths of documents and pages. As such, users may find it difficult to locate documents within the platform. For instance, a single project can generate multiple documents across multiple practice groups and/or multiple organizations. In order to assist with organization, documents may be organized into document spaces, which serve as a central location of all documents related to a particular project or created by a particular project team or individual. However, even within a given document space, there may be a large number of documents having varied content and organization. Navigating a particular document space may be further complicated due to variations in organizational structure between document spaces created by different teams or individuals. Users may not be aware of the extent of the documents produced and may have to spend significant time finding documents in a workspace. Similarly, failure to find a document may result in duplicate work by other users. As time elapses, many spaces may become less visible or less visited by an employee or other users and may become harder to find. An employee looking for a certain page, for example, may spend time browsing through their history and other communications to try to find a file.

Traditional search functions may not find all relevant documents. For example, traditional search engines may use lexical matching to return its search results. A user searching for a document may be using a synonym instead of an exact term and thus may not be able to find certain relevant documents. Similarly, a user may use search terms that return too many documents. While the desired documents or group of documents may have been returned in the search, the user may not see it. For many users, relying on the search function of a platform may be time-consuming. For example, a user may have to go through many steps to find a document, including opening the search function, going to the advanced settings, setting a set of Boolean terms, scrolling through the pages, and clicking on the document. To find more documents, the user may need to repeat these steps until each document is found.

In some cases, the user may manually create copies of the same documents and organize them into a separate folder. The duplicate documents may take up additional storage space in a server, and the new document organizational scheme may not be known to other users wishing to find a similar set of documents. Users may elect to manually-reorganize pages within a workspace. However, manual reorganization of pages to parent/child/grandchild relationships may not be intuitive to other users and may cause confusion about the location of certain pages. Users may spend time trying to trace back certain documents that have been moved and it may cause frustration.

A content collaboration platform can be used to improve organization of pages within a page tree and may reduce the resources required to identify, retrieve, and/or reorganize electronic content. Specifically, the system may have a semantic sorting service that allows users to view elements within a page tree regrouped according to the semantic relationship of the pages' titles, content, or any other attributes or combination of attributes. The grouped set of pages may be associated with a section header, generated at a backend application, that may be used to categorize the group of pages.

The semantic sorting user interface may be integrated in the navigational panel of the graphical user interface (GUI) of the content collaboration platform. The GUI may include a workspace, document space, or, more simply, a space. The space may have a content panel and a navigational panel. In some embodiments, the space may also include search functions, setting options, and other interactive areas for the user. The content panel may display content from a user-created page. Within the content panel, users may edit, create, add labels, and so on. In some examples, the content panel fills a significant portion of the GUI.

The navigational panel may include a page tree. The page tree may be organized as a list of elements that are arranged in a hierarchical structure to illustrate the hierarchical relationship between the corresponding documents or pages (e.g., parent, child, grandchild hierarchy). The page tree may help a user navigate through various pages quickly and/or assess what pages are available in the page tree. Upon a user selection of an element, the GUI is configured to cause display (e.g., at a client device) of page content of the selected element in the content panel. Users with the requisite permissions may alter the hierarchical structure of a page within the page tree.

As discussed above, the default organization of the page tree may be due to user-defined hierarchical relationships between the pages or documents. However, a user-defined hierarchical organization of a page tree may make it difficult for other users to find content. For example, different users may use unique criteria to organize data unknown to others, some users may store files in personal folders, and so on. The page tree may also be organized using alternative criteria, such as last updated, alphabetical, and so on. Similar to the user generated criteria, alternative criteria may not help a user browsing through each page element without additional context (e.g., without a header) grouping pages by category.

The electronic content collaboration platform may include an automatic semantic sorting option. This option may sort pages within a navigational panel based on a semantic similarity criteria. A user may select a semantic sorting option through a drop-down menu, a button, or any other command. In some implementations, the semantic sorting option is included within a menu of multiple sorting or formatting options that can be applied to the elements of a page tree.

The semantic sorting service uses semantic or linguistic analysis to group pages. The analysis may be performed based on the title, the content, the labels, or any combination thereof of each of the pages within the workspace. Linguistic analysis may be performed using any suitable method. For example, the service may use pre-defined datasets composed of word pairs with a relatedness degree estimation (e.g., shortest-path linking of two concept nodes). The analysis may also be performed using a vector space model to correlated words and textual context from a text corpus. Machine learning and/or deep learning methods may be used to gauge the linguistic similarity in a dataset.

The semantic sorting service visually rearranges the workspace of a content collaboration platform. As explained above, a user working within a space may have access to a set of user-created pages displayed as elements in the navigational panel. The default mode or first mode of the navigational panel may be the user-defined hierarchical structure of the elements. In response to a user selection of a semantic sorting option, the sorting service may extract each of the page elements and exclude the parent elements from the user-defined hierarchy. The extracted page elements are used in the semantic similarity analysis of the service which yields a semantically-related group of pages classified under a semantically-relevant section header. This can be called the second mode of the navigational panel. In some examples, the second mode may include the header level (parents) and the element level (children), regardless of the hierarchical level of the elements in the first mode. In some examples, the user-defined hierarchical structure is maintained and a user may toggle between the first mode and the second mode.

Each of the headings in the semantic sort view may be automatically generated. The headings may be selected based on extracted keywords or key phrases. For example, a grouping of pages may be associated with a semantic similarity criteria. Once these groupings are defined, a keyword extraction algorithm may be used to extract the most used or most important words of each group. The extracted keywords may be used as headings. In some cases, additional words may be added to the extracted keywords to generate the headings.

A user may provide feedback on the semantic sorting view. For example, while the navigational panel is in the second mode, a user may drag an element within the page tree to classify the element under a different header. The user preferences may be saved such that, upon toggling to the second mode at a later time, the user-specified locations of the element will be maintained. User preferences can also be used to retrain the sorting service. For example, a backend application may pool a set of similar user feedback to provide input to a training model. In some implementations, user feedback may be a thumbs down/thumbs up menu. In some examples, user feedback may be elicited via a drop down menu that allows a user to indicate the preferred location of an element. A service may collect user feedback and periodically retrain a model to reflect a set of user preferences.

More generally, a semantically similar grouping may facilitate finding pages within the space, regardless of a user-defined hierarchy of the space. A user may be able to navigate the space more intuitively because pages relating to a semantically similar topic are displayed under a common header. For example, a header in the semantic sort view may be “LAUNCH SCHEDULE” and the set of pages grouped under that header may be “LAUNCH SCHEDULE Q1,” “LAUNCH SCHEDULE Q2.” “LAUNCH SCHEDULE Q3,” and so on. A user looking for all pages related to the launch schedule may easily scan the list of available launch schedule-related pages.

As described herein, a semantic analysis process may be used to reorganize or sort the elements of a page tree. For example, a backend application (e.g., in a host server) may receive the user input to semantically sort pages within a space. Upon receiving this input, the application may query a database to obtain those sets of pages within the space. These sets of pages may be used to compute vectors for each of the pages. In some embodiments, the set of vectors may be computed for each page prior to the user selection of the automatic semantic sorting option. Once the vectors are computed, clusters may be generated based on a semantic similarity criteria. For example, vectors closer in proximity may meet the semantic similarity criteria while vectors further from each other are not semantically similar. The semantic similarity criteria may be calculated using any suitable algorithm, as may be known to one of skill in the art. Once the clusters are generated, each of the generated clusters may be used to extract a keyword or a key phrase. Keyword extraction may be performed through any suitable algorithm, as may be known to one of skill in the art. For example, keyword extraction may use a statistical approach, a linguistic approach, graph-based approaches, machine learning approaches, and/or any other combination thereof.

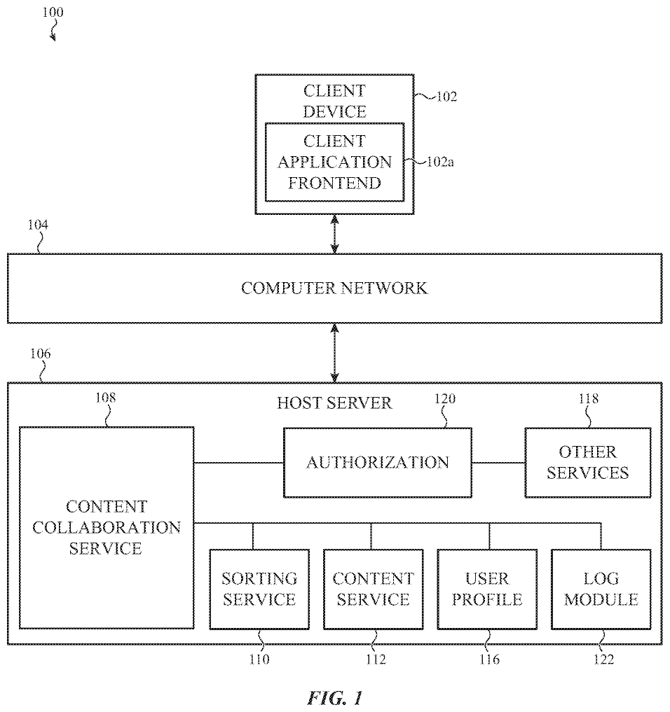

These foregoing and other embodiments are discussed below with reference to FIGS. 1-7. However, those skilled in the art will readily appreciate that the detailed description given herein with respect to these figures is for explanation only and should not be construed as limiting.

FIG. 1 depicts an example of a system 100 for semantically sorting pages within a space in an electronic collaboration service. A user may select an option to semantically sort pages of a workspace, or simply a space, within an element tree. The system may automatically generate keywords or key phrases that are semantically similar to a set of pages within the space and display those keywords or key phrases as section headers in the semantic sort view of the navigational panel (e.g., the second mode of the navigational panel). The system may also visually rearrange the elements within the element tree using the headers as parents of the element tree and the elements as children of those headers.

As described herein, the system 100 may be used to create, manage, and display content for electronic pages or documents. Electronic pages or documents may be created for a particular document space, also referred to herein as a “workspace” or simply a “space.” The system 100 is depicted as implemented in a client-server architecture or client-service architecture, but it may be appreciated that this is merely one example and that other communications architectures are also possible. In accordance with the examples provide herein, the system 100 of FIG. 1 can be used to provide a series of interfaces to a document management system, page management system, content collaboration system, or other electronic content management system via a computer network 104.

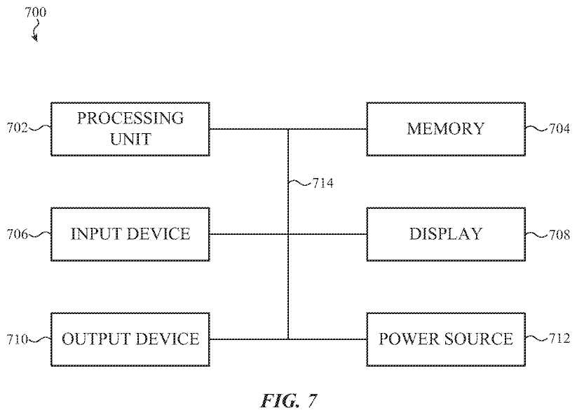

A user accesses the electronic collaboration platform using a frontend application in the client device. In particular, the architecture of system 100 allows a client device 102 to remotely access, via a frontend application 102a, electronic content of the collaboration platform. The frontend application 102a may be a dedicated client application (such as a web browser application, a mobile device application, or a native client application). The frontend application may provide one or more graphical user interfaces for interfacing with a backend application or services. The client device 102 may be a desktop computer, laptop, smart phone, tablet, or any other device suitable to access the frontend application 102a. The client device 102 may include a display, processing unit, computer memory, and other hardware components, as may be known to one of skill in the art. An example device including hardware elements is described below with respect to FIG. 7.

Through the internet, a client device 102 may access the services of the content collaboration platform. As shown in FIG. 1, the client device 102 is communicably coupled to a computer network 104. The computer network 104 is configured to access a host server 106. The computer network 104 may include a distributed network which may include local networks, gateways, and networking services provided by one or more internet service providers. An authenticated user may access spaces, create, search, view, share, edit, and sort content in their client device via the computer network 104 through the services provided by the host server 106.

The host server 106 may provide services and/or physical resources that support the content collaboration platform. In some examples, the host server 106 includes one or more servers and uses one or more virtual or physical computing resources (collectively referred in many cases as a “cloud platform”). In some cases, the host server(s) 106 can be physically collocated. In other cases, each server is positioned in a geographically unique location. The host server 106 may be referred to as hosted services, which may provide multiple platform services. For example, the multiple platform services may include a content collaboration service 108, which may also be referred to as a document management platform, a document management service, a document collaboration platform, or a document collaboration service. The platform services may also include a sorting service 110, a content store or content service 112, and one or more user profiles 116. The multiple platform services may also include other services 118, which may include an issue tracking service, a code management service or code repository, messaging and event feed services, label services, and other collaboration or data management services.

A platform service of the multiple platform services may be implemented as one or more instances of the platform service executing on one or more host servers 106. The multiple platform services may also provide different services including, for example, issue tracking services for creating, managing, and tracking issues for software development, bug tracking, and/or information technology service management (ITSM) services. For example, the host server 106 may host a content collaboration service 108, an authentication/authorization service 120, a sorting service 110, and other services 118. The host server 106 may also include an event log module 122, and a user profile module 116. The host server 106 may also have a local cache or local storage of electronic documents or pages of user-generated content 112.

The content collaboration service 108 may provide an interface to the client device 102 to the one or more backend applications, and/or software platforms, such as a documentation platform or an issue tracking platform. For example, the client device 102 may execute a frontend application that consumes services provided by the content collaboration service 108. Accordingly, a user of a client device 102 can create, edit, search, and/or view electronic documents, pages, or electronic content using the interface provided by the content collaboration service 108. By way of a non-limiting example, the interface provided by the content collaboration service 108 may be webservice based, such as a REpresentational State Transfer (REST) webservice. The electronic documents, pages, or electronic content may be transferred between a client device and a host server using one or more of JavaScript Object Notation (JSON), Extensible Markup Language (XML), HyperText Markup Language (HTML), and/or a proprietary document format.

The content collaboration service 108 allows a user to create, edit, search, and/or view electronic documents, pages, or electronic content based on authentication and/or authorization of the user using the authentication/authorization service 120. The authentication/authorization service 120 authenticates a user based on user credentials, which may include a username or other user identification, password or pin, biometric data, or other user-identifying information. The user credentials may be stored and tracked using a token, authentication cookie, or other similar data element. Upon successful authentication/authorization of a user, the content collaboration service 108 may access a user profile module 116 to get a user profile associated with a user of a client device. The user profile associated with the user may suggest various permissions of a user for creating, editing, accessing, searching, and/or viewing various electronic documents, pages, or electronic content. The user profile associated with the user may also identify other details of the user, including, but not limited to, a role of a user in an organization, one or more groups to which a user is a member, other users of the one or more groups to which the user is a member, one or more projects related to the user, one or more issues or tickets (managed by an issue tracking system) the user is assigned to, and so on. The user profile may include, but is not limited to, user permission settings or profiles, and user history that may include user logs or event histories, system settings, administrator profile settings, content space settings, and other system profile data associated with the backend applications described herein and associated with the user. Accordingly, the user of the client device may create, edit, access, search, and/or view electronic documents, pages, or electronic content based on permissions granted to the user based on the retrieved user profile, and labels may be recommended to the user according to the permissions granted to the user, and/or based on permissions granted to the user with respect to various electronic documents, pages, or electronic content. The backend application may suppress display of electronic documents where the user does not meet the authorization credentials.

The content collaboration service 108 may interface with one or more services within the host server 106. For example, other services 118 may provide a user interface to other applications or services such as an issue tracking system configured to create, edit, search, or view an issue or ticket on the issue tracking system. Thus, the content collaboration service 108 may generate electronic documents, pages, or electronic content which may also include data associated with one or more issues managed by the issue tracking system. The content collaboration service 108 may also retrieve a set of user-generated pages in response to an automatic semantic sorting command from the user (e.g., using the frontend application). A sorting service 110 may receive the set of pages from the user content database.

The system includes one or more event log modules 122, which may track and/or store user actions, system events, or other data generated in accordance with activity performed by the system users. Specifically, the event log module 122 may include navigation events that are generated in response to user selection or navigation to various pages, documents, or other content on the system. The navigation events may be used to determine which pages have been navigated to by a user either before or after a particular page or document. In some cases, the navigation events are used to determine a set of pages or documents that have been navigated to or viewed by the user within a session or designated time frame. The user event log 122 may also be used to store other properties of a session including, for example, average dwell time for a page or document, user interactions with content including likes, comments, and other feedback, or other application use or other user activity observed during a session or time period. Details of the various events may be accessed by the sorting service 110 for determining a user's preferences and/or feedback in presenting a semantically sorted page tree.

As described above, the semantic sorting service may use a variety of linguistic analysis tools to sort elements in a navigational panel according to a linguistically-similar criteria. In some examples, the semantic sorting service 110 computes a set of vectors from the set of pages received from the content collaboration service 108 and/or the content service 112. The sorting service 110 computes this set of vectors based on one or more attributes of the set of pages, such as title of each of the set of pages. In other examples, the vectors are computed based on the title, the content, the labels, the creation date, and/or any other suitable attribute. When more than one attribute is considered, the sorting service 110 applies different weights to each of the attributes. For example, the title of a page content may be considered more heavily than any other attribute. In some embodiments, the weighing of each attribute is based on a predefined weighing matrix. In other examples, the weight of each attribute may be generated through a machine learning module trained based on a set of pages. The model may be retrained based on user feedback or a corpus of pages extracted from a space within the collaboration platform.

Once vectors are calculated, each vector may be used to generate a set of clusters. Each cluster from the set of clusters may have a semantic similarity metric in a vector space. In some embodiments, vectors close in distance in a vector space are semantically similar while vectors further away in a vector space are not semantically similar. A model may use a pre-defined distance metric as a threshold criteria to determine semantic similarity. For example, vectors further in distance than the predetermined threshold criteria are not in the same cluster. The semantic similarity criteria may be based on metrics such as cosine similarity, Euclidean distance, Manhattan distance, Minkownski distance, Jaccard similarity, or any other text similarity algorithms, as may be known to one of skill in the art.

Once clusters are generated, the sorting service may be configured to generate keywords for each of the computed clusters. In some examples, the sorting service may extract keywords and/or key phrases. In some examples, keywords may be generated by assigning keywords from a list of controlled vocabulary. The extracted keywords may include, for example, common words used in each of the clusters. In other examples, the generated keyword may be a known synonym of a collection of relevant words within the page titles. Each keyword may be associated with each of the generated clusters. Each of the extracted keywords or key phrases is used as section headers in the second mode of the navigational panel (e.g., the semantic sort view).

In the second mode of the navigational panel, the set of pages from each of the generated clusters and the generated keywords may be associated with each child and parent relationship. The system may cause display, at a client frontend application, of the navigational panel in a second mode. In this mode, a user may browse the navigational panel according to semantically-similar categories allowing the user to find pages without needing to find the user-defined location of that page within the space and without utilizing the search function. A user may elect to toggle between the second mode and the first mode of the navigational panel. In some examples, the user-defined hierarchical structure of the elements in the first mode is not modified by switching modes. Thus, a user may toggle between the first and second modes without hierarchical/structural changes to the space.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not exhaustive and do not limit the disclosure to the precise forms recited herein. To the contrary, it will be apparent to one of ordinary skill in the art that many modifications and variations are possible in view of the above teachings.

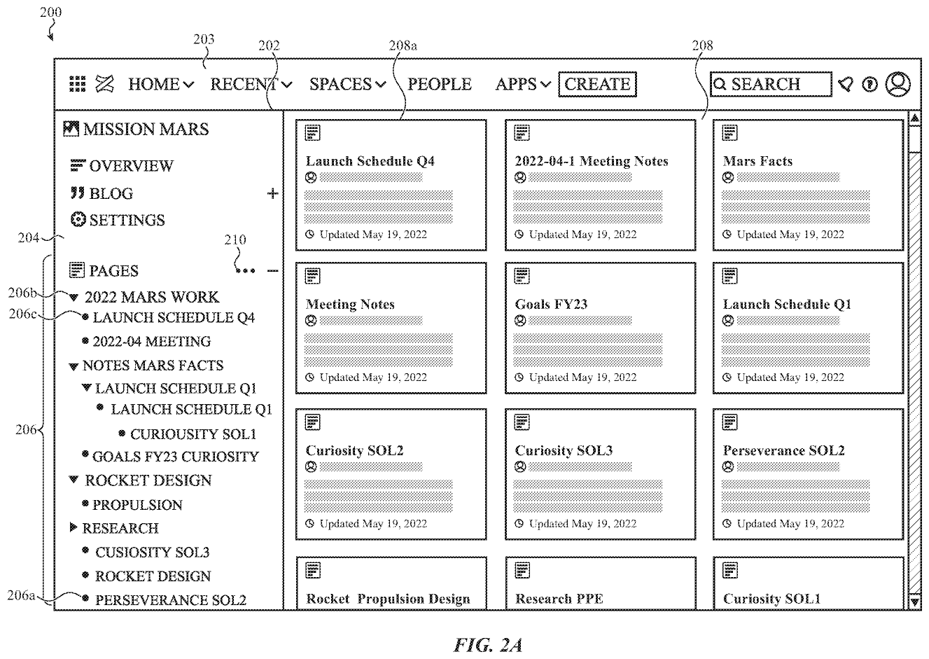

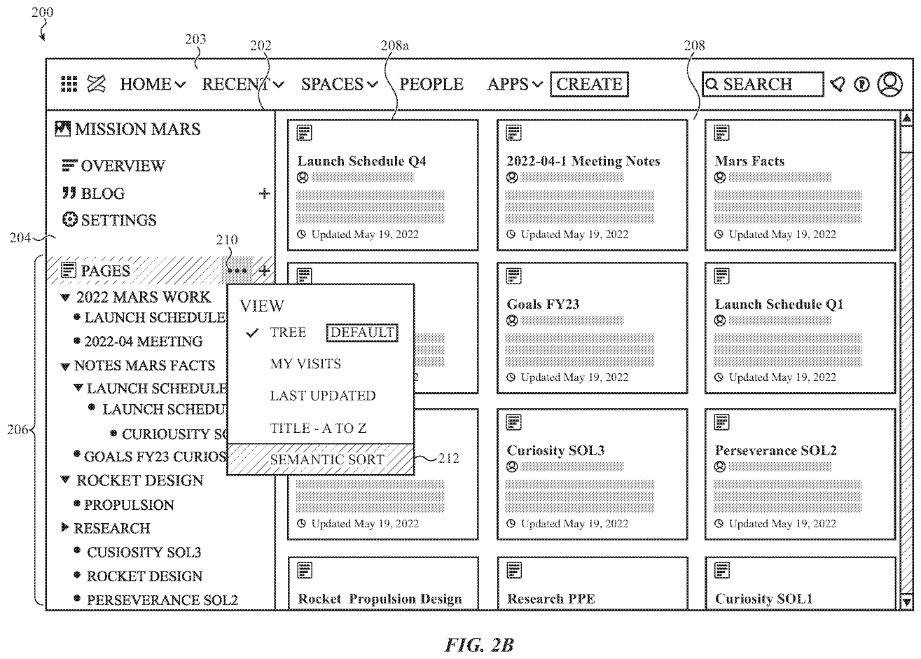

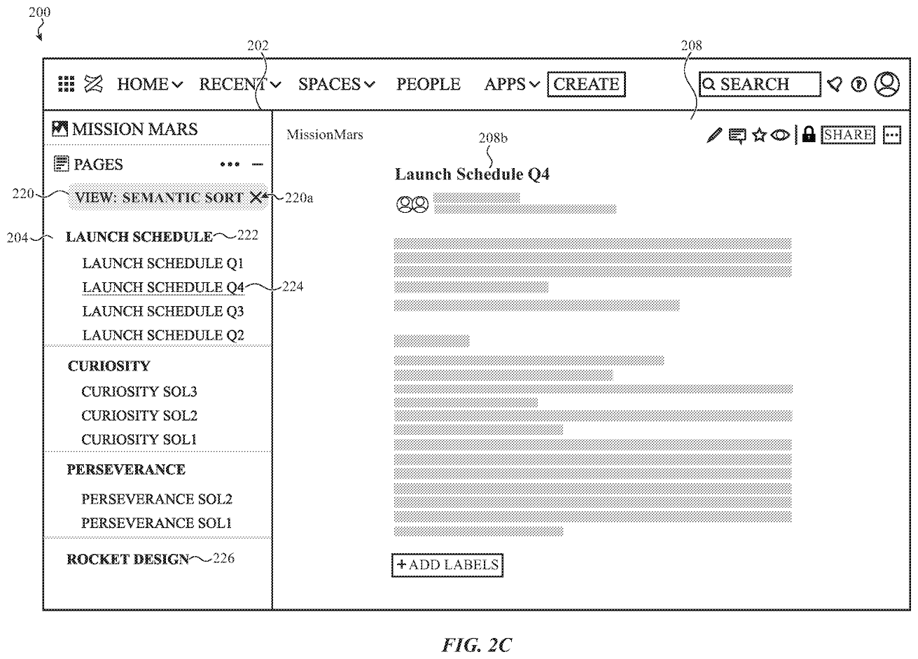

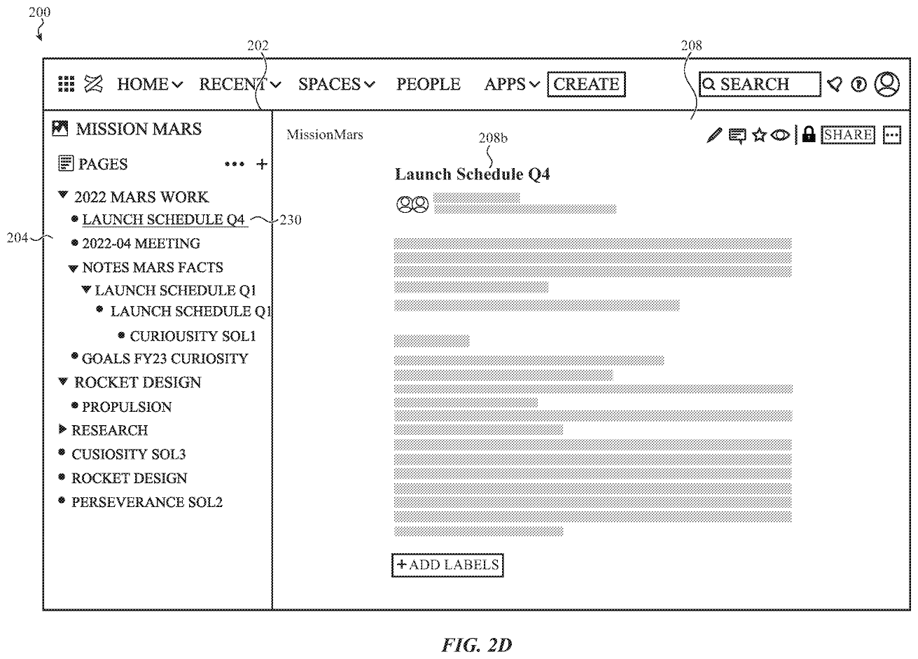

FIGS. 2A-2D depict examples views of graphical user interfaces provided by a frontend or client application operating on a client device. The graphical user interfaces 200 provided by the frontend client application include a semantic sorting function, which may be used to automatically regroup user content according to a semantic criteria.

As described in the following figures, a user with appropriate permissions with regard to a particular page or document may use the semantic sorting service to visually rearrange user content within a space in a navigational panel 204. In response to a user selection of a semantic sorting option in a navigational panel, the GUI may be updated. The updated GUI may be a second mode of the page tree organized under headings generated from keywords or key phrases extracted from a cluster of pages. The second mode also displays a group of semantically-related pages grouped under a respective heading. For example, each heading is a parent element of a corresponding group of page elements.

FIG. 2A illustrates an example graphical user interface 200 of an electronic collaboration platform. The graphical user interface shown in the figure illustrates the navigational panel in a first mode (e.g., having a user-defined hierarchical structure) including a semantic sort option. In response to a selection of the semantic sort option, the navigational panel toggles between the first mode and the second mode. In the second mode, the user-defined hierarchical structure of the page tree is replaced by section headers that are automatically generated from extracted keywords or key phrases. Each of the headers represents a semantic relationship with respect to a set of pages grouped under each of the headers. From a second mode, a user may toggle back to a first mode of the navigational panel. The GUI shown in FIG. 2A permits a user to switch to a sorting scheme that is most convenient to the user.

The GUI allows a user to view page elements in the content panel and/or the navigational panel which facilitates user navigation of the space. The graphical user interface 200 shown in FIG. 2A is a rendering of an electronic document, page, or electronic content on a client device. The electronic document, page, or electronic content may be rendered on the client device by a content collaboration service upon authorization/authentication of a user by the authentication/authorization service and based on permissions granted to the user according to a user profile associated with the user. In one example, the graphical user interface 200 has various partitions/sections displaying different content. For example, the graphical user interface 200 includes user-generated content within a space 202. A user of an electronic collaboration platform may have access to multiple spaces. Users may navigate to other spaces, applications, or other functions outside of the space view using the top panel menu 203.

A user can use the content panel for a variety of functions. A first state allows a user to create, edit, or modify an electronic document, page, or electronic content. This state may be referred to as a document edit mode, page edit mode, editor user interface, content-edit user interface, a page-edit user interface, or document-edit user interface. A second state allows the user to view, search, comment on, or share the electronic document, page, or electronic content. This state of the graphical user interface may be referred to as a view mode, document view mode, page view mode, viewer user interface, content-view user interface, a page-view user interface, or document-view user interface. The graphical user interface may be implemented in a web browser client application using HTML, JavaScript, or other web-enabled protocol.

The navigational panel 204 allows a user to navigate through a space, view settings, and so on. The navigational panel 204 may include hierarchical elements, such as a page tree 206. The page tree 206 may have an array of page elements 206a, an array of tree elements, or simply, “elements.” Each element 206a can be hierarchically arranged within the page tree. The hierarchical position of each of the elements 206a may be user-defined. For example, the page tree may have parent elements 206b. Arranged under a parent element 206b may be children elements 206c. The hierarchical relationships may include grandchildren, and so on. This user-defined hierarchical arrangement of the page tree may be referred to as a first mode of the navigational pane. In some examples, the first mode is the default view of the navigational panel. In the first mode, a user may elect any hierarchical structure, regardless of semantic relationship. While in a first mode, a user selection of an element may cause display of page content of the selected element in the content panel 208. Within the content panel a user may view the contents of an element, create new content, edit, and so on. The content panel may also display an array of page frames 208a which may be selectable by a user.

FIG. 2B illustrates an example GUI of a sorting selection menu 210, including a semantic sort option. The page tree 206 may include a sorting selection menu 210. In some examples, the sorting selection menu 210 may be a dropdown menu, a series of buttons, a kebab menu, and so on. A user selection of the sorting selection menu 210 may present sorting option views, such as a tree view, last updated, alphabetical, and semantic sort option 212. The pages and the semantic sorting options presented in the page tree 206 may be selectable by a user with view permissions with respect to the pages in the page tree.

The semantic sort option may arrange elements of a space in groups predicted to be semantically related. These predictions or estimates can be computed using a number of different techniques. For example, predictions may be based on the author of the page content, the creation date, the subject matter, labels, and/or any other attributes or combinations of attributes. As an example, the technique use may be a semantic or linguistic technique that analyzes the titles of each page element. Each of the attributes considered may be accorded different weights, based on the performance (e.g., measured from user feedback) of the predicted semantic similarity.

One example semantic or linguistic analysis is vector analysis. Vector analysis can be used in natural language processing to measure the semantic similarity between two page titles. Vector analysis accounts for the context of each of the titles to measure the similarity. Preprocessing of the data is performed in some examples. For example, an algorithm may normalize, standardize, and/or feature engineer the data. In some cases, words of less importance (e.g., and, of, are, is, and so on) may be removed from the dataset. The resulting vectors may be embedded in a vector space. As an example of such methodology applied by the sorting service, upon user selection of the semantic sort option 212, a backend application (e.g., at a host server 106 from FIG. 1), may query a database within the content collaboration platform to obtain elements within the workspace. Each of the elements in the space is converted to a vector (e.g., through an encoder or any other module, as may be known to one of skill in the art). The vector calculation may be on a sentence level to take into account content-specific values, rather than a word by word comparison. The vectors representing each of the extracted elements may then be embedded in a vector space. The similarity between two vectors may be computed using any suitable algorithm, such as cosine similarity.

Based on the similarity calculation between each of the vectors, the service may cluster semantically similar vectors representing each of the page elements. Clustering can be used to group vectors that are measured to be semantically similar. This grouping may be displayed to a user under a common heading. Clustering may be performed using any suitable distance metric. For example, the clusters may be determined using cosine-similarity to determine if elements are semantically similar. As explained above, similarity calculations may take into account one or a combination of the page's title, content, labels, creation date, update date, originating user, and so on. In some examples, page elements from each of the spaces may be converted to vectors and embedded into a vector space prior to a user selection of the semantic sort option. Elements may be converted into vectors and added to the vector space when pages are created and/or modified. The sorting service may use a variety of clustering options. For example, the service may use hierarchical clustering where the defined number of clusters is not used and each cluster is defined based on the distance criteria. In other examples, a predefined number of clusters may be specified. The service may use unsupervised machine learning algorithms for clustering. As an example, a specified number of centroids may be used as an input to generate clusters, each centroid represents the location of the center of the cluster. Once the centroid is identified, each vector may be allocated to a centroid.

Keywords or key phrases can be extracted from each cluster. The keywords or key phrases extracted can be part of the section headers for the navigational panel under which each of the groupings from the formed clusters may be organized under. A keyword extractor may take into account any feature or combination of features, for example, the case of a word, the position of the word with respect to the content, the word frequency, word relatedness to the context, and so on. Each of these features may be combined heuristically to compute a score. The score may reflect how meaningful a keyword or key phrase is with respect to the group of elements. Keywords meeting a score criteria may be selected by the sorting service to generate headers. In some examples, the service ranks keywords or key phrases and selects the top one, top two, top three, and so on of the keywords to generate the header.

The sorting service may use any appropriate keyword extraction algorithm. For example, the sorting service may use a corpus-independent and language independent approach to keyword extraction. In this example, the keyword extraction algorithm may extract relevant keywords in different languages or use a variety of project-specific or industry-specific jargon without the need for specific training models.

FIG. 2C shows an example GUI of the navigational panel 204 in a second mode. In the second mode, the page tree view may be updated to group elements by a semantic criteria. In this view, a user may scroll through the navigational panel to locate an element within a space without altering the user-defined hierarchical structure from the first mode. As explained above, the second mode may be shown in response to the user selection of the semantic sorting option. The updated display of the navigational panel 204 may have section headers 222 that may be generated from the extracted keyword or key phrases explained above. Each section header 222 may be displayed as parent elements of a set or group of page elements 224. The elements 224 grouped under section header 222 are semantically related to its corresponding header. Put differently, the set of elements belong to a cluster computed according to a semantic similarity criteria.

As shown in FIG. 2C, the user-defined hierarchical structure (e.g., the parent/child relations) of the page tree from FIG. 2A (e.g., first mode) may change in a semantic sort view (e.g., second mode). In other words, the backend application may flatten the hierarchy of each element prior to calculating the vectors. A set of “flattened” page elements means that the calculated vectors do not have the context of its parent element(s). In other words, page elements having grandparent and/or parent elements may be extracted as if the page did not have any parent/grandparent relationship. The sematic sort view 220 may show each element under a common hierarchical level from other elements in the space.

As explained above, the user may adjust the view of the page tree according to the user's preference. For example, the section headers 222 may be collapsible. In response to a user selection of a collapse button adjacent to the section header 222, the GUI may update to suppress display of the page elements 224 grouped under the collapse header. In some examples, a user selection of a section header 222 is configured to display, in the content panel, the group of page elements 224 grouped under the page header as page frames.

The page elements 224 displayed to a user depends on the view permission associated with each of the pages. Display of page elements that are not accessible by the user may be suppressed from the navigational panel. For example, a page within a space may be set as “private” by a content creator. In response to a semantic sort command by another user, the private page is not visible to the user, regardless of the semantic similarity of the private page. At a backend application, the content collaboration service may exclude from the query pages that the user is not permitted to view. In some examples, the restricted page may be part of the cluster and excluded from display at a frontend application.

In some examples, the second mode may also display subheaders. As may be known to one of skill in the art, generated clusters may be finer or coarser depending on the criteria and/or algorithm used. The semantic sorting algorithm may generate a set of keywords based on coarser clusters and/or a set of keywords based on finer clusters. Upon selecting the semantic sort option, the updated navigational panel may show hierarchically organized headers (e.g., headers and subheaders). A header may correspond to a coarser cluster and subheaders may correspond to a finer cluster. In some examples, the keyword extraction algorithm from the sorting service may use higher-ranked keywords extracted from the cluster to generate subheaders.

In some situations, a page is a standalone cluster. For example, a space may not have a significant number of pages to cluster, or a page may have a unique topic such that it may not be semantically similar to any pages. A backend application may present the standalone page element (e.g., element 226) as a parent element in the semantically sorted view. In some cases, the backend application may extract a keyword and group the standalone page under the extracted keyword.

In some examples, the keywords or key phrases within the page tree may be selectable. In response to a user selection of a keyword or key phrase, the content panel may update to display the children element of the keyword or key phrase as page frames within the content panel. A user may browse either the content panel 208 and/or the navigational panel 204 under the selected keyword or key phrase to find related pages. A user selection of an element causes to display page content 208b in the content panel.

As explained above, in some examples, the semantic sort option may visually rearrange the page tree for a user while maintaining the user-defined hierarchical structure of each of the elements within the space. As a result, a user can toggle between the second mode of the navigational panel and the first mode of the navigational panel. To toggle between modes, the GUI may have a close command 220a, for example. The close command 220a may be within the navigational panel.

FIG. 2D depicts an example GUI after a transition from a second mode of the navigational panel (e.g., a semantic sort view) to a first mode of the navigational panel (e.g., a user-defined hierarchical view). While in the second mode, a user may select an element to view and/or edit content in the content panel. Upon closing, the selected element remains highlighted or accentuated with respect to other elements within the page tree (e.g., by underlining the element within the page tree) within the user-defined hierarchical structure of the first mode. This allows a user to see the page location within the user-defined structure of within the space without clicking through page properties of the page via other functions. Knowing the user-defined hierarchical structure can allow a user to navigate to the selected page through the default view in the future, for example.

As shown in FIG. 2D, in response to a user closing the semantic sort view, a display of the navigational panel may be updated from the second mode to the first mode. To toggle to the first mode, the display on the navigational panel 204 may update to show the user-defined hierarchical structure of the space within the navigational panel 204. In some examples, users can update their default view preferences. In such cases, closing the semantic sort view may cause a display of a navigational panel to update in accordance with recently visited, favorites, alphabetical order, or any other criteria.

In some examples, as explained above, the content panel may continue to display page content of the page that was last selected by the user. In other words, the last page clicked 230 by the user in the second mode continues to be displayed in the content panel, regardless of the navigational panel mode. As a result, reverting to the default view from the semantic sort view may cause a user to see the user-defined location of the page within the space, as explained above. For example, if a user selects the page “LAUNCH SCHEDULE Q4” in a semantic sort view (e.g., second mode) and then closes the semantic sort view, the navigational panel may update to the first mode and show that the last page clicked 230 has a parent element of “2022 MARS WORK,” as illustrated in FIG. 2D. As such, a user may elect to find the selected page directly from the parent folder, or the user may revert to the semantic sort view to find the page in other occasions.

In some examples, a user with appropriate view/edit permissions may rename a page element in the semantic sort view. In response to the user renaming the element, a backend application may recompute a vector based on the renamed page element and generate a new vector representation for the renamed page element. The new vector representation can be embedded in the vector space and grouped or clustered according to its semantic similarity with respect to other vector representations within the vector space. In some cases, title changes of an element may result in the element being grouped under a different header. The navigational panel may update to display the renamed page element under the new computed grouping and corresponding new header. The new header may be an existing header. In some examples, however, the backend application may generate new keywords or key phrases and display updated headers.

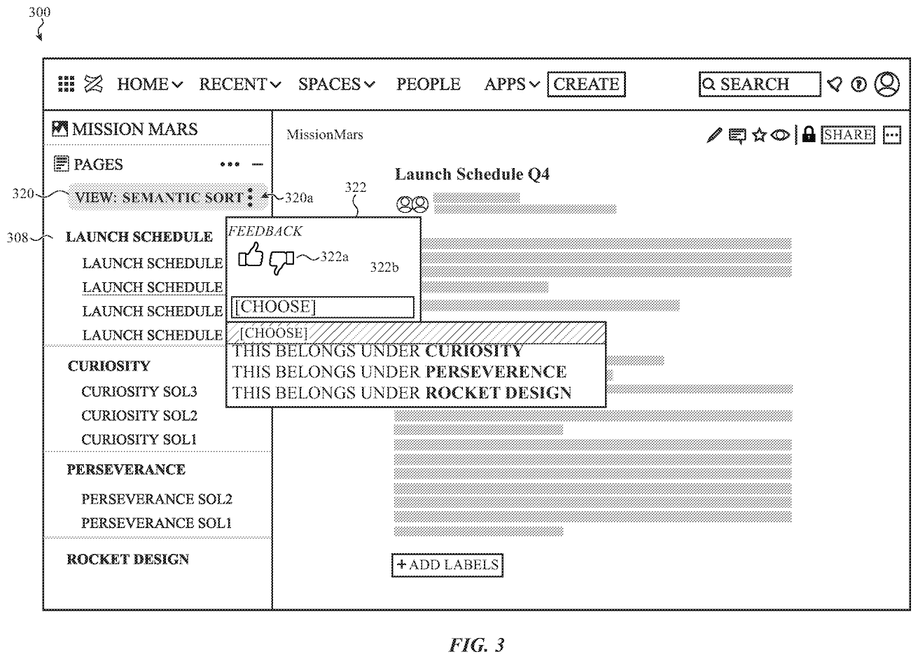

FIG. 3 shows an example content collaboration platform view having user feedback options. The user feedback options can be used to retrain a model to improve the semantic sorting service. The figure shows several examples of user feedback. For example, the application may have thumbs up/thumbs down buttons to gauge a user's satisfaction with the sorting display. Similarly, users may elect to reclassify a specific tree element under a different section header. These feedback options may be compiled by a service and used to retrain a model that yields user-preferred groupings.

As illustrated in FIG. 3, the content collaboration platform GUI 300 may include a user feedback option for the semantic sorting view. In particular, a navigational panel 308 may include a user feedback option for the page tree and/or for each of the elements within the page tree. As explained above, the semantic sort view of a navigational panel may include, as parent elements in the page tree, section headers. These section headers may be automatically generated, at a backend application, from extracted keywords or key phrases from each cluster. For example, the space may have a set of pages that are extracted from a database, encoded, and embedded in a vector space to generate clusters based on semantic similarity. Each cluster may be grouped, in the navigational panel, as children elements of the header corresponding to that cluster.

Once the semantic sort view is selected, the navigational panel may update to be in a second mode. For example, the navigational panel may be updated according to a semantic sort view 320 of page elements within the space. Within the navigational panel, the GUI may display an indicator of the current view, which may include a selectable menu 320a. The selectable menu may have a user feedback menu 322 and/or an exit option. The exit option, as discussed above, allows a user to toggle between the second mode and the first mode. In some examples, the GUI may include a toggle view option that is configured to toggle between modes of the navigational panel.

The user feedback menu may include a thumbs up/thumbs down option 322a. A user satisfied with the semantically sorted view may select the thumbs up option. By contrast, a user dissatisfied with the semantically sorted view may select a thumbs down option. Upon receiving user feedback, a backend application may be configured to retrain a sorting model to account for user feedback. For example, the backend application may use a set of user inputs to retrain the model. If a set of users are in a statistically significant fashion, dissatisfied with the sorting results, the model may be retrained to, for example, refine clusters or it may apply different keyword extraction algorithms. A statistical insignificant data point (e.g., a single user out of hundreds of users) may be ignored by the backend application as an outlier.

The user feedback menu 322 may include a suggestion option 322b. The suggestion option 322b may be a drop-down menu. The drop-down menu may prompt the user to re-categorize an element within the semantic sort view. For example, a user may indicate that an element belongs under a different section header. Upon receiving user feedback, a backend application may pool the user feedback and retrain a model according to the user feedback. For example, in response to a positive indicia or in response to a positive input from a user, a service may increment a weighing factor or bias the model to continue to produce the displayed arrangement. In response to a negative indicia or negative input from a user, a service may decrement a weighing factor or bias a model to produce a second arrangement different from the displayed arrangement. As another example, in response to a negative indicia, a service may compile a predetermined set of user inputs and, in response to the inputs, bias a model to produce the user-defined results for each of the inputs. In some embodiments, the user feedback may be sent to a specialist for further review.

The user feedback menu may have different user interfaces. As an example, the user feedback menu may appear on a page-by-page basis within the element tree. A user may hover (e.g., with a mouse pointer) over a page to reveal a thumbs up/thumbs down option. In response to a user selecting a thumbs down option, a suggestion menu may appear. This menu may be a pop-up menu, for example. A user may suggest a grouping that the user believes is a better fit for the element (e.g., under a different header).

The user may also elect to give feedback to the section headers. For example, the user may hover over the header to reveal a thumbs up/thumbs down option. If a user selects the thumbs down option, a drop-down menu may be displayed. The drop-down menu may include suggestions for alternative headers. For example, alternative headers may be populated in a drop-down menu with a list of higher-ranked key phrases from the keyword extraction algorithms. The drop-down menu may also or alternatively include suggestions that the header is not relevant to the semantic grouping. In some examples, a page element may be semantically similar to more than one group. A second mode may display the page elements in both locations. Alternatively, the page element may display the page element in the group that is predicted to be semantically closest.

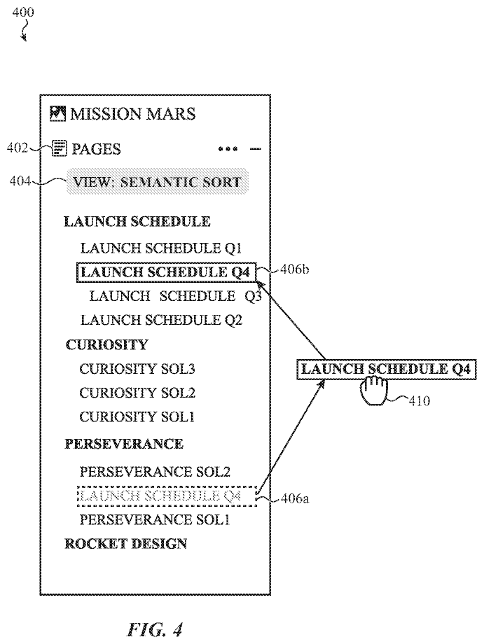

FIG. 4 depicts a user feedback option of the navigational panel while in the semantic sort view. As shown in the figure, the user may have a “drag and drop” option that allows a user to rearrange page elements within the navigational panel in a second mode. This option allows a user to further rearrange elements according to user preferences. In some cases, this option may be beneficial because a user can contemporaneously rearrange the page tree without waiting for a retraining algorithm to take effect. Furthermore, using drag and drop options may allow a service to save user preferences.

The navigational panel, as shown in FIG. 4, may include additional user feedback and/or customization options. For example, the navigational panel 400 may have a page tree 402 that displays the semantic sort view 404. A user may change the automatically generated hierarchical structure of the semantic sort view 404. In the semantic sort view, the user may select an element 406a within the page tree 402 and drag and drop 410 onto a different grouping (e.g., under a different header). The user may also elect to drag and drop element 406a onto a standalone element within the page tree. As described above, the user-selected location of the element 406b may be saved (e.g., under a user profile). Thus, a user may exit from the semantic sort view and, upon returning to the view, element 406b may be in the user-selected location.

A backend application may gather data and retrain a semantic sorting service based on user feedback from the drag and drop function. In some examples, a backend application may collect a set of user feedback to retrain a model. In other examples, each user profile may be associated with a different sorting model. In yet other examples, the frontend application may display a “CUSTOM SORTING” option based on the semantic sorting model and the user feedback received. As such, a user may organize a navigational panel without rearranging the user-generated hierarchical organization of the space.

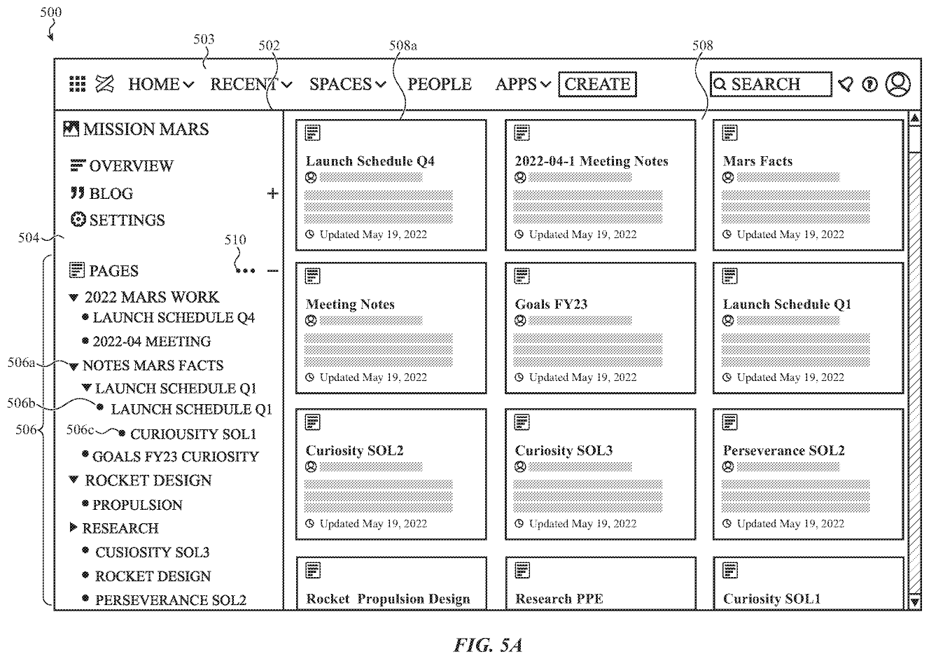

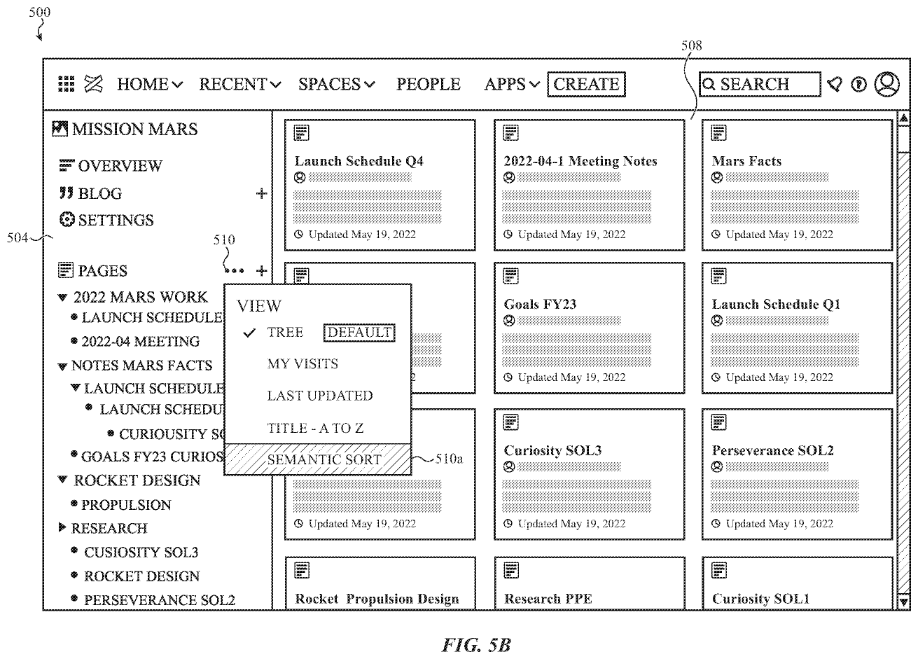

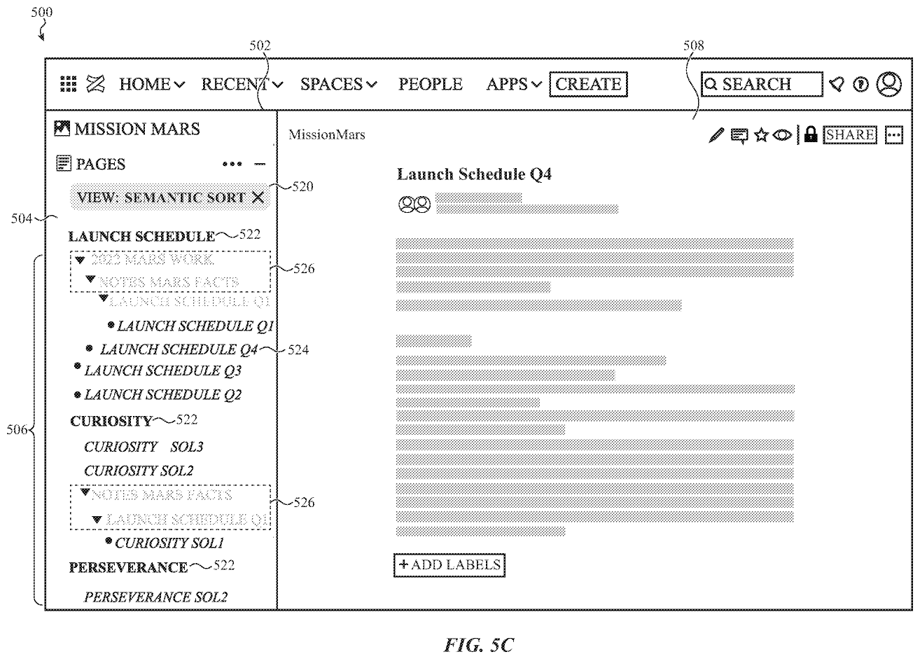

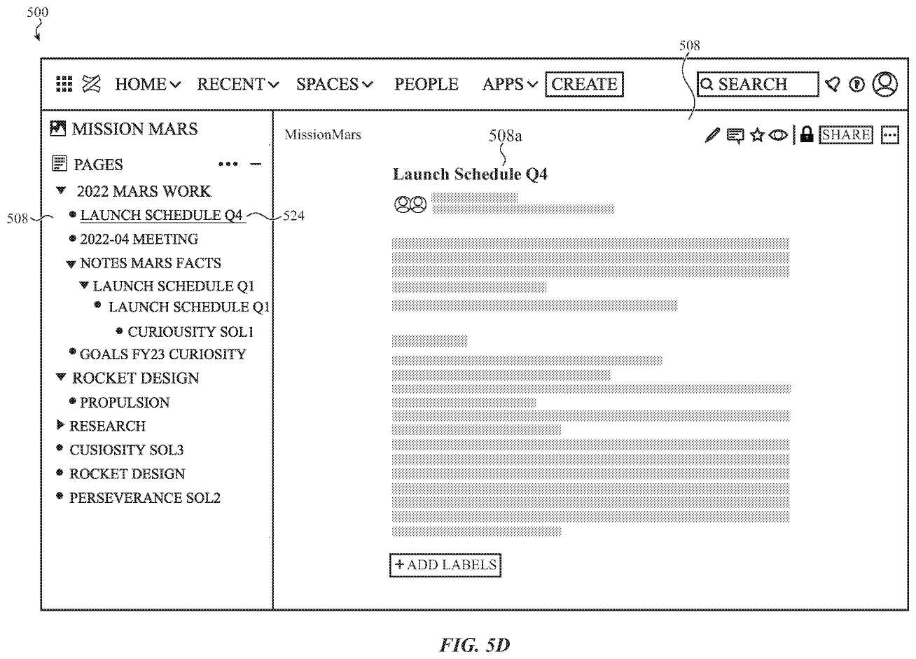

FIGS. 5A-5D depict an example view of the content collaboration platform graphical user interface 500. As explained in FIGS. 2A-2D above, the user collaboration platform may have a semantic sorting service that allows a user to view a navigational panel according to a semantic criteria. This semantic criteria may facilitate a user's navigation of a space and may make it easier for a user to find content because of the intuitive nature of a semantic organization. The content collaboration platform may include a content panel for viewing, editing, and creating documents; a navigational panel having a page tree that displays an array of user generated pages as hierarchical elements within the page tree; and a top menu for selecting different spaces, communicating with other users, and/or creating new pages, similar to those described in FIGS. 2A-2D above.

FIGS. 5A-5D show an example GUI where a user can toggle between a default view (first mode) and a semantic sort view (second mode). In the second mode, the navigational panel displays semantically sorted elements but also displays the user-defined hierarchical structure for each of the elements. This can allow a user to browse the navigational panel in a semantically-sorted manner while being able to see the actual location of each of those elements within the space.

FIG. 5A illustrates an example graphical user interface 500 of an electronic collaboration platform. As described above in FIG. 2A, the graphical user interface shown in the figure illustrates the navigational panel 504 in a first mode (e.g., having a user-defined hierarchical structure) including a semantic sort option. In response to a selection of the semantic sort option, the navigational panel toggles between the first mode and the second mode. In the second mode, the user-defined hierarchical structure of the page tree is replaced by section headers that are automatically generated from extracted keywords or key phrases. Each of the headers represents a semantic relationship with respect to a set of pages grouped under each of the headers. From a second mode, a user may toggle back to a first mode of the navigational panel.

A content collaboration platform may have multiple interaction areas that allows a user to browse, edit, collaborate, and create in the platform. For example, a content collaboration platform GUI 500, as depicted in FIG. 5A, includes a graphical user interface of a workspace 502. Within the workspace, the user interface has a navigational panel 504, a content panel 508, and a top panel 503. The navigational panel 504 is configured to allow a user to quickly navigate through page elements, access settings, access blogs, and so on. To access a page, a user can use a navigational panel 504 having a page tree 506. The page tree 506 may include an array of page elements that may be hierarchically organized. In some examples, this hierarchical organization is user-defined. The page tree 506 includes a parent element 506a which may house any number of page objects and/or other elements. For example, parent element 506a may house children 506b and grandchildren 506c.

As explained above, the hierarchical organization of the page tree 506 may be user-defined. For example, a user may save a set of pages under the same parent element (e.g., a folder). Other users may create new pages using a unique hierarchical structure from the first user. As a result of this workflow, many pages that have similar topics, titles, and content may be stored under different parent elements making it difficult to visualize pages within a workspace 502. A semantically sorted page tree may allow a user to more conveniently browse the elements of a space. As depicted, user-defined hierarchies are maintained, allowing a user to toggle from one mode of a navigational panel to another mode.

FIG. 5B illustrates an example GUI of a sorting selection menu 510, including a semantic sort option. The sorting selection menu 510 allows the user to toggle from one sorting mode to another sorting mode. Similar to the interface depicted in FIG. 2B, the page tree 506 may include a sorting selection menu 510. In some examples, the sorting selection menu 510 may be a dropdown menu, a series of buttons, a kebab menu, and so on. A user selection of the sorting selection menu 510 may present sorting option views, such as a tree view, last updated, alphabetical, and semantic sort option 212. The pages and the semantic sorting options presented in the page tree 506 may be selectable by any user with view permissions with respect to the elements in the page tree. The navigational panel may include a sorting selection menu 510 having an array of sorting options. The sorting selection menu 510 may be a drop-down menu, meatball menu, kebab menu, bento menu, and so on. The menu 510 may be displayed at or adjacent to the page tree 506 on the navigational panel. As shown in FIG. 5B, upon user selection of sorting selection menu 510, a semantic sort option 510a may be displayed.

A semantic sort option 510a may refer to a sorting system that groups elements according to their semantic similarity. For example, pages referring to a “schedule” may be semantically similar. As another example, pages referring to the same project name may be semantically similar. As explained above, semantic similarity may be more or less granular. For example, a “launch schedule” may not be semantically similar from a “deliverables schedule.” A sorting service, such as service 110 in FIG. 1, may use any suitable algorithm, training model, or any combination thereof to group (e.g., by clustering) and generate keywords that are caused to display in an updated view of a navigational panel 504.

As explained above, various attributes may be used to compute vectors or values of a data set (e.g., a set of pages within the page objects). For example, a sort service may consider the titles of pages in computing vectors. A sort service may also consider, for example, the content of the pages, labels generated by a label service at a backend application, and so on. Each attribute may be assigned equal or different weights. For example, a page titled “MEETING NOTES” may have, in its content, repeated instances of the word “SCHEDULE.” In addition, the “MEETING NOTES” page may include an image of a Gant chart. A sorting service may assign, taking collectively the title, the content, and the images, a semantic similarity score meeting that meets a criteria compared to other pages having within their titles “SCHEDULE.”

In some examples, a sorting service may consider similar images, similar text and images, or any combination thereof in its semantic groupings. For example, a sorting service may consider the content of pages including images. The images may be embedded in the same vector space as the string text. The semantic sorting service may generate section headers based on both the embedded images and embedded text. As an example, an image of a nozzle for a rocket may be semantically similar as pages discussing nozzle design. As a result, a user may find related images and text grouped together in a semantic grouping within the navigational panel. Similarly, a semantic sorting service may take into account video, audio, and/or any other content within a page.

FIG. 5C shows an example GUI of the navigational panel 504 in a second mode. As explained above for FIG. 2C, in the second mode, the page tree view may be updated to group elements by a semantic criteria. In this view, a user may scroll through the navigational panel to locate an element within a space without altering the user-defined hierarchical structure from the first mode. As explained above, the second mode may be shown in response to the user selection of the semantic sorting option. The updated display of the navigational panel 504 may have section headers 522 that may be generated from the extracted keyword or key phrases explained above. Each section header 522 may be displayed as parent elements of a set or group of page elements 524. The elements 524 grouped under section header 522 are semantically related to its corresponding header. Put differently, the set of elements belong to a cluster computed according to a semantic similarity criteria.

As depicted in FIG. 5C, a display of a navigational panel may be updated based on the user selection of the semantic sort view 520 shown in FIG. 5B. In particular, section headers 522 generated from the extracted keywords or key phrases may be presented as parent elements within the page tree 506. Under each section header 522, a set of page elements, such as element 524, may be grouped under a corresponding header. Each of the grouped pages corresponds to a cluster and its corresponding header is extracted key phrases from each cluster.

In some examples, an element may retain its user-defined hierarchical folder structure. In other words, a user selecting a semantic sort object does not alter the hierarchical structure of the space. As a result, the user may toggle from one mode of the navigational panel (e.g. the semantic sort view mode) to another mode of the navigational panel (e.g., the default user-defined structure). However, in other embodiments, a backend application reassigns page elements from the user-defined hierarchical structure to the semantically sorted hierarchical structure. After this reassignment, the first mode and the second mode of the navigational panel may be identical.

When the user-defined structure of elements is not altered, a semantic sorting view may display the user-defined hierarchical structure 526 within the navigational panel. Such display may signal to a user the location of the semantically similar pages. As such, a user may choose to manually reorganize the user-defined hierarchical structure 526 or the user may search for an element in the first mode when accessing the page. As an example, a user may also hover over the user-defined hierarchical structure 526 (e.g., parent elements of the navigational panel) to hide those parent elements, thus displaying the page elements as one level (see, e.g., FIG. 2C). As another alternative, the workspace may have user settings which may allow a user to customize view settings of the semantic sort command.

As depicted in FIG. 5C, a user may toggle between a first mode and a second mode. For example, a user may exit the semantic sort view (e.g., by clicking “X”). Upon toggling views, as depicted in FIG. 5D, the navigational panel may update to return to a first mode. A page 508a displayed within the content panel may be continued to be displayed. The navigational panel may highlight the selected page element 524. The selected page element 524 may also maintain the user-defined hierarchical structure.

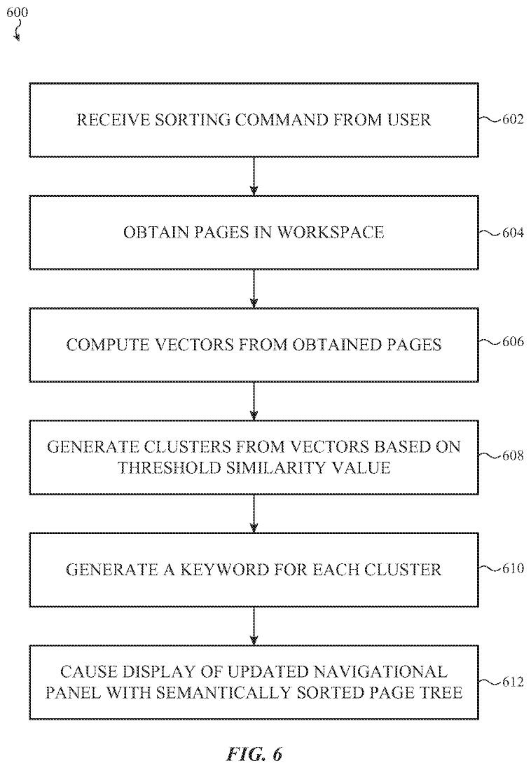

FIG. 6 depicts a method 600 for semantically sorting a set of pages within a workspace of a content collaboration platform. The depicted method visually rearranges a workspace of a content collaboration platform, allowing a user to intuitively browse through a page tree. A semantic clustering criteria is applied to the titles and/or any attributes of the page elements. As explained above, the content collaboration platform may have, within a navigational panel, a selectable semantic sorting option that is communicatively coupled to a host service. The host service may have a semantic sorting service that is configured to cluster pages in a workspace and generate section headers in accordance with those clusters.

At step 602, a backend application may be configured to receive the semantic sorting command from the user. As explained above, the semantic sorting command may be a button, drop down menu, or any other suitable user interface feature that allows a user to toggle from one mode of the navigational panel to another mode.

In response to the receipt of the semantic sorting command, at step 604, a backend application may obtain a set of pages associated with a workspace. The set of pages may be pages accessible to the user according to the user's authorization profile. At step 606, the obtained pages from step 604 may be used to compute vectors. The vectors may be computed based on at least one attribute of the pages. For example, the vectors may be computed based on the title of each of the pages. The computed vectors may be embedded in a vector space. At step 608, the computed vectors in the embedded vector space may be used to generate clusters. The clusters may be calculated using any suitable means. The resulting clusters may have a threshold semantic similarity value between a center point, for example. Each page within a cluster may be semantically similar (according a threshold metric) to each of the other set of pages within the same cluster.

At step 610, a keyword or key phrase may be extracted from each of the calculated clusters. Similar to explained above, the extracted keyword or key phrase may be extracted using any suitable algorithm or keyword extraction criteria taking into account multiple attributes of the cluster. For example, casing?, frequency, placement of the word, and so on may be considered when extracting key phrases. Each of the extracted keywords from each of the clusters may be an input to generate section headers to be displayed at a frontend.

At step 612, a backend application communicably coupled to a frontend application may cause display of an updated navigational panel. The updated display of the navigational panel may be a second mode. The second mode includes the section headers corresponding to each of the clusters and a set of page elements associated with each of the clusters grouped under the section headers. As a result, the page tree may display a hierarchically organized set of elements comprising section headers as parent elements and user-created elements as children. Each parent and child may be semantically similar. A user, thus, may intuitively browse a page tree to find pages related semantically to each other regardless of the pages' user-defined hierarchical folder structure.

FIG. 7 shows a sample electrical block diagram of an electronic device 700 that may perform the operations described herein. The electronic device 700 may in some cases take the form of any electronic device, including client devices, and/or servers or other computing devices associated with the system 100 from FIG. 1. The electronic device 700 can include one or more of a processing unit 702, a memory 704 or storage device, input devices 706, a display 708, output devices 710, and a power source 712. In some cases, various implementations of the electronic device 700 may lack some or all of these components and/or include additional or alternative components.

The processing unit 702 can control some or all of the operations of the electronic device 700. The processing unit 702 can communicate, either directly or indirectly, with some or all of the components of the electronic device 700. For example, a system bus or other communication mechanism 714 can provide communication between the processing unit 702, the power source 712, the memory 704, the input device(s) 706, and the output device(s) 710.

The processing unit 702 can be implemented as any electronic device capable of processing, receiving, or transmitting data or instructions. For example, the processing unit 702 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 700 can be controlled by multiple processing units. For example, select components of the electronic device 700 (e.g., an input device 706) may be controlled by a first processing unit and other components of the electronic device 700 (e.g., the display 708) may be controlled by a second processing unit, where the first and second processing units may or may not be in communication with each other.

The power source 712 can be implemented with any device capable of providing energy to the electronic device 700. For example, the power source 712 may be one or more batteries or rechargeable batteries. Additionally, or alternatively, the power source 712 can be a power connector or power cord that connects the electronic device 700 to another power source, such as a wall outlet.

The memory 704 can store electronic data that can be used by the electronic device 700. For example, the memory 704 can store electronic data or content such as, for example, audio and video files, documents and applications, device settings and user preferences, timing signals, control signals, and data structures or databases. The memory 704 can be configured as any type of memory. By way of example only, the memory 704 can be implemented as random access memory, read-only memory, Flash memory, removable memory, other types of storage elements, or combinations of such devices.

In various embodiments, the display 708 provides a graphical output, for example associated with an operating system, user interface, and/or applications of the electronic device 700 (e.g., a chat user interface, an issue-tracking user interface, an issue-discovery user interface, etc.). In one embodiment, the display 708 includes one or more sensors and is configured as a touch-sensitive (e.g., single-touch, multi-touch) and/or force-sensitive display to receive inputs from a user. For example, the display 708 may be integrated with a touch sensor (e.g., a capacitive touch sensor) and/or a force sensor to provide a touch- and/or force-sensitive display. The display 708 is operably coupled to the processing unit 702 of the electronic device 700.

The display 708 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 708 is positioned beneath and viewable through a cover that forms at least a portion of an enclosure of the electronic device 700.

In various embodiments, the input devices 706 may include any suitable components for detecting inputs. Examples of input devices 706 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 706 may be configured to detect one or more types of input and provide a signal (e.g., an input signal) corresponding to the detected input. The signal may be provided, for example, to the processing unit 702.

As discussed above, in some cases, the input device(s) 706 may include a touch sensor (e.g., a capacitive touch sensor) integrated with the display 708 to provide a touch-sensitive display. Similarly, in some cases, the input device(s) 706 may include a force sensor (e.g., a capacitive force sensor) integrated with the display 708 to provide a force-sensitive display.

The output devices 710 may include any suitable components for providing outputs. Examples of output devices 710 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 710 may be configured to receive one or more signals (e.g., an output signal provided by the processing unit 702) and provide an output corresponding to the signal.

In some cases, input devices 706 and output devices 710 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 702 may be operably coupled to the input devices 706 and the output devices 710. The processing unit 702 may be adapted to exchange signals with the input devices 706 and the output devices 710. For example, the processing unit 702 may receive an input signal from an input device 706 that corresponds to an input detected by the input device 706. The processing unit 702 may interpret the received input signal to determine whether to provide and/or change one or more outputs in response to the input signal. The processing unit 702 may then send an output signal to one or more of the output devices 710, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B. or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present disclosure should not be limited by any of the above-described exemplary embodiments but is instead defined by the claims herein presented.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., drivers licenses, passports, government identification cards or credentials, and so on); protected health information (e.g., medical records, dental records, and so on); financial, banking, credit, or debt information; third-party service account information (e.g., usernames, passwords, social medial handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

It may be further appreciated that a request-response RESTful system implemented in whole or in part over cloud infrastructure is merely one example architecture of a system as described herein. More broadly, a system as described herein can include a frontend and a backend configured to communicably couple and to cooperate in order to execute one or more operations or functions as described herein. In particular, a frontend may be an instance of software executing by cooperation of a processor and memory of a client device. Similarly, a backend may be an instance of software and/or a collection of instantiated software services (e.g., microservices) each executing by cooperation of a processor resource and memory resources allocated to each respective software service or software instance. Backend software instances can be configured to expose one or more endpoints that frontend software instances can be configured to leverage to exchange structured data with the backend instances. The backend instances can be instantiated over first-party or third-party infrastructure which can include one or more physical processors and physical memory devices. The physical resources can cooperate to abstract one or more virtual processing and/or memory resources that in turn can be used to instantiate the backend instances.

The backend and the frontend software instances can communicate over any suitable communication protocol or set of protocols to exchange structured data. The frontend can, in some cases, include a graphical user interface rendered on a display of a client device, such as a laptop computer, desktop computer, or personal phone. In some cases, the frontend may be a browser application and the graphical user interface may be rendered by a browser engine thereof in response to receiving HTML served from the backend instance or a microservice thereof.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

As described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

In other examples, the data can conform to a particular data transfer protocol—whether proprietary or standardized—such as, but not limited to: universal serial bus (typically referred to as “USB”); peripheral component interconnect express standard (typically referred to as “PCIe”); controller area network (typically referred to as “CAN”); on-board diagnostics (typically referred to as “OBD” or “OBD-II”); serial peripheral interface bus (typically referred to as “SPI Bus”); high-definition multimedia interface (typically referred to as “HDMI”); ethernet; integrated drive electronics (typically referred to as “IDE”); serial or parallel advanced technology attachment (typically referred to as “SATA” or “PATA”); inter-integrated circuit bus (typically referred to as “I2C”); and so on. In other cases, more than one protocol, encoding, and/or encryption technique or technology can be used in parallel.

What is claimed is:

1. A method for semantically sorting electronic content of an electronic document collaboration service, the method comprising:
causing display of a graphical user interface of a document space, the graphical user interface comprising:
a content panel configured to display page content of a page; and
a navigational panel comprising a hierarchical element tree having a set of tree elements, each tree element of the set of tree elements selectable to cause display of page content of a respective page in the content panel;
causing display of the hierarchical element tree in the navigational panel in a first mode in which the set of tree elements is arranged in an order determined by a hierarchical relationship between adjacent tree elements;
in response to receiving an automatic semantic sorting command, obtaining page content for a set of pages within the document space;
computing, at a backend application, a set of vectors, each vector determined using page content of a respective page of the set of pages within the document space;
generating, at a backend application, a set of page clusters using the set of vectors;
extracting from each page cluster of the set of page clusters, a keyword; and
causing display of the hierarchical element tree in the navigational panel in a second mode in which the set of tree elements is arranged in a grouping determined by the set of page clusters.

2. The method of claim 1, wherein the second mode comprises:
a set of section headers generated from each extracted keyword, each section header from the set of section headers caused to display as a parent within the hierarchical element tree; and
each set of page clusters arranged under a respective section header, each page cluster of the set of page clusters caused to display as a child of the respective section header.

3. The method of claim 1, further comprising:
causing display, in the second mode, of a toggle view option; and
in response to a user selection of the toggle view option, updating display of the navigational panel to the first mode.

4. The method of claim 3 wherein:
in response to a user selection of an element, the content panel is configured to display the page content; and
upon toggling to the first mode, the navigational panel comprises:
the set of tree elements arranged in the order determined by the hierarchical relationship between the adjacent tree elements; and
the selected element positioned within the hierarchical relationship, the selected element is configured to be accentuated with respect to the set of tree elements.

5. The method of claim 1, wherein:
the graphical user interface of the document space is displayed in a web browser;
in response to a user selection of an element in the hierarchical element tree, display the page content in the content panel; and
in response to a user selection within the content panel, the content panel can be transitioned between edit mode and view mode of the page content.

6. The method of claim 1, wherein each vector of the set of vectors is calculated using a respective title of a respective page of the set of pages.

7. The method of claim 6, wherein each vector of the set of vectors is calculated based at least in part on a respective content of a respective page of the set of pages.

8. The method of claim 1, further comprising:
in the second mode, in response to a user drag input with respect to a page element in the hierarchical element tree, change a position of the page element from a first location to a second location within the hierarchical element tree.

9. The method of claim 1, further comprising:
in response to a user selection, change the hierarchical relationship of the adjacent tree elements of the first mode to be equal to the second mode.

10. A method for semantically reorganizing a page tree within a navigational panel, the method comprising:
causing display of a graphical user interface of a space, the graphical user interface comprising:
a navigational panel comprising a page tree, the page tree comprising:
a set of user-generated page elements; and
a set of parent elements configured to hierarchically arrange the set of user-generated page elements; and
a content panel configured to display, in response to a user selection of a page element, page content of the selected page element;
causing display of the navigational panel in a first mode in which a hierarchical arrangement of the page tree is user-generated;
in response to a user selection of a semantic sort option, querying the set of user-generated page elements of the space;
calculating, at a backend application, a semantic similarity metric, the semantic similarity metric calculated from page content of each of the set of user-generated page elements;
clustering, at a backend application, groups of user-generated pages, each of the user-generated pages in each cluster meeting a semantic similarity criteria;
generating, at a backend application, a set of key phrases, each of the key phrases from the set of key phrases extracted from each of the generated clusters; and
causing display of the navigational panel in a second mode, the second mode comprising:
a section header generated from the set of extracted key phrases; and
a subset of pages, wherein the subset of pages corresponds to a generated cluster.

11. The method of claim 10, wherein:
the section header is displayed as a parent element of the page tree; and
each page of a subset of pages is displayed as a child element of a corresponding section header.

12. The method of claim 10, further comprising:
querying, at a backend application, at least one restricted page, each restricted page associated with user view permissions; and
suppressing display, at a frontend application, of the at least one restricted page in the second mode.

13. The method of claim 10, further comprising:
In the second mode, in response to a user selection of an element, cause display of page content associated with the selected element in the content panel; and
in response to a user selection, toggling the navigational panel from the second mode to the first mode, wherein the selected element is caused to display as underlined within the navigational panel.

14. The method of claim 10, further comprising:
ranking, at a backend application, a group of extracted key phrases, each ranking based on weighing at least on a frequency of a key phrase with respect to a cluster;
selecting a lowest ranked key phrase from the group of extracted key phrases as the section header of the cluster; and
causing display of the section header in the second mode.

15. A method for semantically sorting pages in a content collaboration platform in response to a user selection of a semantic sort view, the method comprising:
causing display of a content collaboration platform space, the content collaboration platform space comprising:
a content panel configured to display page content of a user-selected page;
a navigational panel configured to display a page tree, the page tree having an array of user-generated elements contained within the content collaboration platform space; and
a sorting menu comprising a selectable semantic sort view;
in response to a user selection of a semantic sort view within the sorting menu, extracting an array of attributes from each user-generated element from the array of user-generated elements within the content collaboration platform space;
obtaining, from the array of attributes, a set of vector representations;
forming groupings from the set of vector representations, each vector representation within each grouping meeting a semantic similarity criteria;
extracting, from each of the groupings, a key phrase; and
causing display of the semantic sort view of the navigational panel, the semantic sort view comprising:
at least one header generated from at least one key phrase extracted from a grouping; and
at least one grouping of an array of elements corresponding to the at least one generated header.

16. The method of claim 15 further comprising:
in response to a user selection of a page element in the semantic sort view, causing display of page content corresponding to the selected page element in the content panel; and
in response to a user selection of a section header, causing display of a set of page frames in the content panel, each page of the set of page frames corresponds to each page element of the grouping under the at least one generated header.

17. The method of claim 15, wherein:
the array of attributes comprises at least each title of each of the array of user-generated elements and page content comprising an image.

18. The method of claim 15, further comprising:
in response to a user input renaming a page element, computing a new vector representation for the renamed page element;
grouping the new vector representation in accordance with the semantic similarity criteria of the new vector representation; and
causing display of an updated navigational panel, the updated navigational panel having the renamed page element under a computed grouping.

19. The method of claim 15, wherein:
the semantic similarity criteria is calculated based at least on cosine similarity; and
a keyword extraction criteria is calculated at least based on statistical methods.

20. The method of claim 15, further comprising:
in the semantic sort view, in response to a user drag input of a page element, update the navigational panel to display the page element in a user-selected location; and
update, at a backend, a user profile to save the user-selected location.
